(19) United States
(12) Patent Application Publication
(10) Pub. No.: US 2026/0169365 A1
(43) Pub. Date: Jun. 18, 2026

(54) PROJECTOR

(71) Applicant: SEIKO EPSON CORPORATION, Tokyo (JP)

(72) Inventor: Takuo YONEYAMA, AZUMINO-SHI (JP)

(21) Appl. No.: 19/423,230

(22) Filed: Dec. 17, 2025

(30) Foreign Application Priority Data
Dec. 18, 2024 (JP) 2024-221430

(51) Int. Cl. G03B 21/20

(52) U.S. Cl. CPC G03B 21/208; G03B 21/2013

(57) ABSTRACT

A projector of the present disclosure includes an image generation unit including a first image generation region that generates first image light of a first wavelength band and a second image generation region that generates second image light of a second wavelength band; an integrator optical system that superimposes the first image light and the second image light emitted from the image generation unit and forms an image to generate an intermediate image; and a projection optical device that enlarges and projects an intermediate image onto a projection surface. A back focus position of the projection optical device coincides with a position of the intermediate image. The first image generation region and the second image generation region are disposed along a second direction in the same plane, which is orthogonal to a first direction that is an emission direction of the first image light and the second image light.

The present application is based on, and claims priority from JP Application Serial Number 2024-221430, filed Dec. 18, 2024, the disclosure of which is hereby incorporated by reference herein in its entirety.

### BACKGROUND

### 1. Technical Field

The present disclosure relates to a projector.

### 2. Related Art

A projector capable of projecting a color image using only a single light modulation element is known. JP-A-2003-121930 discloses a projector including a light source such as a high pressure mercury lamp, a liquid crystal panel that modulates light from the light source, a color filter that is disposed corresponding to each pixel of the liquid crystal panel and that selectively transmits blue light, green light, and red light included in white light from the light source, and a projection lens. JP-A-2002-04388 discloses a field sequential color type projector including a light source with a light emitter that emits blue light, a light emitter that emits green light, and a light emitter that emits red light, a liquid crystal panel that modulates light from the light source, and a projection lens.

However, the two projectors described above are different from each other in the display method of the color image by a single liquid crystal panel, and have the following problems.

In the case of the projector of JP-A-2003-121930, in each pixel of the liquid crystal panel, light in a specific wavelength band of white light emitted from the light source is transmitted through the color filter, whereas light in a wavelength band other than the specific wavelength band is absorbed by the color filter and does not contribute to display. Therefore, there is a problem that the utilization efficiency of the light emitted from the light source is low and it is difficult to obtain a bright image. If the luminance of the light source is increased indiscriminately in order to obtain a bright image, there is a risk that the color filter will deteriorate.

In contrast, in the projector of JP-A-2002-04388, a color image can be displayed without using a color filter by performing image display in a field sequential color system. However, in this projector, a color breakup phenomenon due to the principle of the field sequential systems occurs, and there is a possibility that the display quality deteriorates.

### SUMMARY

In order to solve the above problem, a projector according to a first aspect includes an image generation unit including a first image generation region that generates first image light of a first wavelength band and a second image generation region that generates second image light of a second wavelength band different from the first wavelength band; an integrator optical system that superimposes the first image light and the second image light emitted from the image generation unit and forms an image to generate an intermediate image; and a projection optical device that enlarges and projects the intermediate image onto a projection surface.

A back focus position of the projection optical device coincides with a position of the intermediate image.

The first image generation region and the second image generation region are disposed in the same plane along a second direction, which is orthogonal to a first direction that is an emission direction of the first image light and the second image light.

### BRIEF DESCRIPTION OF THE DRAWINGS

FIG. 1 is a schematic configuration diagram of a

projector according to a first embodiment.

FIG. 2 is a front view of the light modulation element.

FIG. 3 is a diagram illustrating another configuration example of the light source device.

FIG. 4 is a schematic configuration diagram of a projector according to a second embodiment.

FIG. 5 is a diagram showing a light modulation element and a second lens array in a projector according to a third embodiment.

FIG. 6 is a diagram showing a light modulation element and a second lens array of a comparative example.

FIG. 7 is a diagram illustrating an light path of stray light to an adjacent lens.

FIG. 8 is a schematic diagram illustrating a problem of a projected image.

FIG. 9 is a diagram showing a light modulation element and a second lens array of a first countermeasure example.

FIG. 10 is a diagram showing a light modulation element and a second lens array of a second countermeasure example.

FIG. 11 is a diagram illustrating a light modulation element, a second lens array, and a first lens array according to a third countermeasure example.

FIG. 12 is a diagram illustrating an image generation unit, a second lens array, and a first lens array of a fourth countermeasure example.

FIG. 13 is a schematic configuration diagram of a projector according to a fourth embodiment.

FIG. 14 is a schematic configuration diagram of a projector according to a fifth embodiment.

### DESCRIPTION OF EMBODIMENTS

### First Embodiment

Hereinafter, a first embodiment of the present disclosure will be described with reference to the drawings.

In the drawings used in the following description, in order to make the features of each part easy to understand, characteristic parts may be enlarged for convenience, and for example, the ratio of the dimensions of each component may be different from the actual ratio.

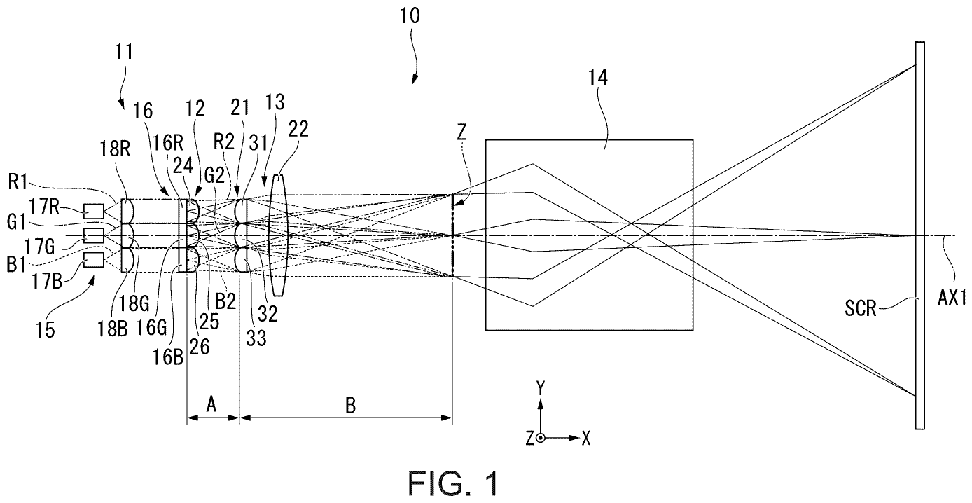

FIG. 1 is a schematic configuration diagram of a projector 10 according to a first embodiment.

As illustrated in FIG. 1, a projector 10 of the present embodiment is a projection-type image display device that displays a color image on a screen SCR. The projector 10 includes an image generation unit 11, a second lens array 12, an integrator optical system 13 including a first lens array 21, and a projection optical device 14. The image generation unit 11 includes a light source device 15 and a light modulation element 16.

In the following description, an XYZ orthogonal coordinate system is used, an axis corresponding to the front-rear direction of the projector 10 and along the emission direction of light from the light source device 15 is defined as an X-axis, a side on which the light travels is defined as a +X side, and a side opposite to the +X side is defined as a −X side. An axis corresponding to the vertical direction of the projector 10 is defined as a Y-axis, the upper side of the projector 10 is defined as a +Y side, and the lower side is defined as a −Y side. An axis corresponding to the left-right direction of the projector 10 is defined as a Z-axis, the front side of the paper surface is defined as a +Z side, and the back side is defined as a −Z side. The X-axis direction in the present embodiment corresponds to a first direction in the scope of the claims. The Y-axis direction in the present embodiment corresponds to a second direction in the scope of the claims. A system optical axis AX1 is defined as an axis that passes through the center of the light modulation element 16 and is parallel to the optical axes of the projection lenses included in the projection optical device 14.

The light source device 15 includes a red light emitter 17R, a green light emitter 17G, a blue light emitter 17B, and collimator lenses 18R, 18G, and 18B. The three light emitters are arranged along the Y-axis direction in the order of the red light emitter 17R, the green light emitter 17G, and the blue light emitter 17B from the +Y side to the −Y side. The red light emitter 17R emits red light R1 in a red wavelength band. The red wavelength band is, for example, a wavelength band of 650 to 770 nm. The green light emitter 17G emits green light G1 in a green wavelength band. The green wavelength band is, for example, a wavelength band of 490 to 550 nm. The blue light emitter 17B emits blue light B1 in a blue wavelength band. The blue wavelength band is, for example, a wavelength band of 430 to 490 nm. The red light emitter 17R, the green light emitter 17G, and the blue light emitter 17B are each formed of a laser diode (LD). The red light R1 in the present embodiment corresponds to the first light in the first wavelength band in the scope of the claims. The green light G1 in the present embodiment corresponds to the second light in the second wavelength band in the scope of the claims. The blue light B1 in the present embodiment corresponds to the third light in the third wavelength band in the scope of the claims.

In the case in which a laser diode is used as the light emitter constituting the light source device 15, the projector 10 can project an image excellent in color reproducibility. In the case of using a laser diode, a diffusion element such as a transmissive diffusion plate for diffusing laser light to homogenize the illuminance distribution may be provided at the light emission side of the light source device 15. It should be noted that a light emitting diode (LED) may be used instead of the laser diode.

The collimator lenses 18R, 18G, and 18B are provided corresponding to the red light emitter 17R, the green light emitter 17G, and the blue light emitter 17B, respectively. The collimator lens 18R, which is disposed so as to face the red light emitter 17R, collimates the red light R1 emitted from the red light emitter 17R at a predetermined divergence angle. The collimator lens 18G, which is disposed so as to face the green light emitter 17G, collimates the green light G1 emitted from the green light emitter 17G at a predetermined divergence angle. The collimator lens 18B, which is disposed so as to face the blue light emitter 17B, collimates the blue light B1 emitted from the blue light emitter 17B at a predetermined divergence angle. Each of the collimator lenses 18R, 18G, and 18B is formed of a convex lens. In the present embodiment, one collimator lens is used for each light emitter, but a configuration in which each color light is shaped into rectangular light using a plurality of collimator lenses may be adopted, for example.

The light modulation element 16 is disposed at the light emission side (+X side) of the light source device 15. The light modulation element 16 modulates the color light fluxes R1, G1, and B1 outputted from the light source device 15 in accordance with image information. The light modulation element 16 is formed of, for example, a transmissive liquid crystal panel. The liquid crystal panel may be a general liquid crystal panel, and although not illustrated in detail, includes components such as an element substrate, a liquid crystal layer, a counter substrate, an incident side dustproof glass, and an emission side dustproof glass. The light modulation element 16 has a plurality of pixels arranged in a matrix in the vertical direction (Y-axis direction) and the horizontal direction (Z-axis direction).

Although not illustrated, an incident side polarizing plate is provided between the collimator lenses 18R, 18G, and 18B and the light modulation element 16. The incident side polarizing plate transmits light having a predetermined polarization direction. In the case where the light emitters 17R, 17G, and 17B are formed of laser diodes as in the present embodiment, the light emitters 17R, 17G, and 17B emit linearly polarized light rays, R1, G1, B1, respectively. Therefore, when the color light R1, G1, and B1 enters the light modulation element 16 while their linearly polarized state is sufficiently maintained, the incident side polarizing plate may be omitted.

Although not illustrated in the diagram, an emission side polarizing plate is provided between a second lens array 12 and a first lens array 21 (to be described later). The emission side polarizing plate transmits light having a polarization direction perpendicular to the polarization direction of the incident side polarizing plate. In the case where there is a space restriction such as a lack of a sufficient gap for accommodating the polarizing plate, the light emission side polarizing plate may be disposed at the light emission side of the first lens array 21. In this case, it is desirable to employ a configuration for suppressing the disturbance of the polarization state due to optical components, such as using quartz as the constituent material of the optical components between the light modulation element 16 and the emission side polarizing plate.

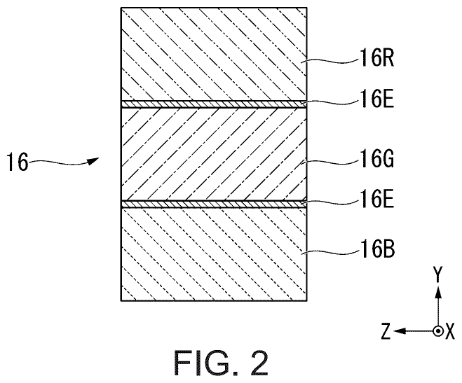

FIG. 2 is a front view of the light modulation element 16 viewed from a direction (+X side) along the system optical axis AX1.

As illustrated in FIG. 2, the light modulation element 16 has a red image generation region 16R, a green image generation region 16G, and a blue image generation region 16B. Each of the red image generation region 16R, the green image generation region 16G, and the blue image generation region 16B is one of three regions obtained by dividing one light modulation element 16 in the Y-axis direction, and has a rectangular shape. Therefore, the red image generation region 16R, the green image generation region 16G, and the blue image generation region 16B are disposed in the same plane along the Y-axis direction, which is orthogonal to the emission direction of each type of image light.

The red image generation region 16R, the green image generation region 16G, and the blue image generation region 16B have the same dimensions in the Y-axis direction and the Z-axis direction and the same areas. The number of the pixels in the horizontal direction (Z-axis direction) of each of the image generation regions 16R, 16G, and 16B is equal to the number of the pixels in the horizontal direction (Z-axis direction) of the liquid crystal panel. The number of pixels in the vertical directions (Y-axis direction) in each of the image generation regions 16R, 16G, and 16B is one third of the number of pixels in the vertical direction in the liquid crystal panel. The red image generation region 16R of the present embodiment corresponds to a first image generation region in the scope of the claims. The green image generation region 16G of the present embodiment corresponds to a second image generation region in the scope of the claims. The blue image generation region 16B of the present embodiment corresponds to a third image generation region in the scope of the claims.

A light shielding region 16E, which does not contribute to image generation, is provided between the red image generation region 16R and the green image generation region 16G and between the green image generation region 16G and the blue image generation region 16B. A light shielding film made of, for example, chromium is provided in the light shielding region 16E. The size of the light shielding region 16E in the vertical direction (Y-axis direction) is sufficiently smaller than the size of each of the image generation regions 16R, 16G, and 16B in the vertical direction (Y-axis direction).

As illustrated in FIG. 1, the red image generation region 16R is disposed at a position facing the red light emitter 17R. The green image generation region 16G is disposed at a position facing the green light emitter 17G. The blue image generation region 16B is disposed at a position facing the blue light emitter 17B. The red image generation region 16R modulates the red light R1 emitted from the red light emitter 17R according to the red image information to generate the red image light R2. The green image generation region 16G modulates the green light G1 emitted from the green light emitter 17G in accordance with green image information to generate green image light G2. The blue image generation region 16B modulates the blue light B1 emitted from the blue light emitter 17B according to blue image information to generate blue image light B2. The red image light R2 in the present embodiment corresponds to the first image light in the scope of the claims. The green image light G2 in the present embodiment corresponds to the second image light in the scope of the claims. The blue image light B2 in the present embodiment corresponds to the third image light in the scope of the claims.

The second lens array 12 is disposed between the image generation unit 11 and a first lens array 21 (to be described later). The second lens array 12 includes a fourth lens 24, a fifth lens 25, and a sixth lens 26. The fourth lens 24, the fifth lens 25, and the sixth lens 26 are arranged along the Y-axis direction. That is, the second lens array 12 is a lens array in which three lenses are arranged in a line along the Y-axis direction. The fourth lens 24 guides the red image light R2 emitted from the red image generation region 16R to a first lens 31 (to be described later). The fifth lens 25 guides the green image light G2 emitted from the green image generation region 16G to the second lens 32 (to be described later). The sixth lens 26 guides the blue image light B2 emitted from the blue image generation region 16B to the third lens 33 (to be described later). Each of the fourth lens 24, the fifth lens 25, and the sixth lens 26 is formed from a convex lens.

In the present embodiment, the second lens array 12 is disposed so as to be in contact with the light emission side surface of the light modulation element 16. It should be noted that the second lens array 12 may be separated from the surface of the light modulation element 16 at the light emission side. The color light beams R1, G1, and B1 emitted from the light emitters 17R, 17G, and 17B are collimated by the collimator lenses 18R, 18G, and 18B, and then enter the light modulation element 16. However, when emitted from the light modulation element 16, the color light beams R1, G1 and B1 may become divergent light beams due to the influence of diffraction or the like inside the light modulation element 16. In contrast, according to the configuration of the present embodiment, since the second lens array 12 is provided at the light emission side of the light modulation element 16, the respective colors of image light R2, G2, and B2 that has become divergent light is picked up by the second lens array 12 and reliably transmitted to the first lens array 21 in the subsequent stage. This makes it possible to increase the utilization efficiency of the image light R2, G2, and B2.

The integrator optical system 13 includes the first lens array 21 and a superimposing lens 22. The integrator optical system 13 superimposes the red image light R2, the green image light G2, and the blue image light B2 emitted from the image generation unit 11, and forms an image of the superimposed light to generate an intermediate image Z.

The first lens array 21 is disposed at the light emission side of the second lens array 12. That is, the first lens array 21 is disposed at the light emission side of the image generation unit 11. The first lens array 21 includes a first lens 31, a second lens 32, and a third lens 33. The first lens 31, the second lens 32, and the third lens 33 are arranged along the Y-axis direction. That is, the first lens array 21 is a lens array in which three lenses are arranged in a line along the Y-axis direction, similarly to the second lens array 12.

The first lens 31 is disposed at a position facing the fourth lens 24. The second lens 32 is disposed at a position facing the fifth lens 25. The third lens 33 is disposed at a position facing the sixth lens 26. The first lens 31 forms an image of the red image light R2 emitted from the fourth lens 24. The second lens 32 forms an image of the green image light G2 emitted from the fifth lens 25. The third lens 33 forms an image of the blue image light B2 emitted from the sixth lens 26. Each of the first lens 31, the second lens 32, and the third lens 33 is formed of a convex lens.

The superimposing lens 22 is disposed at the light emission side of the first lens array 21. The superimposing lens 22 superimposes the red image light R2 emitted from the first lens 31, the green image light G2 emitted from the second lens 32, and the blue image light B2 emitted from the third lens 33 at the light incident side of the projection optical device 14.

In this manner, the first lens array 21 and the superimposing lens 22 generate, at the light emission side of the projection optical device 14, the intermediate image Z, in which the images of the red image generation region 16R, the green image generation region 16G, and the blue image generation region 16B are superimposed and enlarged. Assuming that the distance from the object plane of the light modulation element 16 to the lens principal plane of the first lens array 21 is A and that the distance from the lens principal plane of the first lens array 21 to the intermediate image Z is B, then the magnification of the intermediate image Z with respect to the images of the image generation regions 16R, 16G, and 16B is B/A. It should be noted that the integrator optical system 13 may be formed of a lens group formed by combining a plurality of lenses having the same function as described above. According to this configuration, by increasing the number of lenses, it is possible to suppress chromatic aberration and improve imaging performance.

The projection optical device 14 is disposed at the light emission side of the superimposing lens 22. The back focus position of the projection optical device 14 coincides with the position of the intermediate image Z. The projection optical device 14 is formed of a plurality of projection lenses. The projection optical device 14 enlarges and projects the intermediate image Z generated by the integrator optical system 13 onto the screen SCR. A full-color image is thereby projected onto the screen SCR.

### Effects of First Embodiment

The projector 10 according to the present embodiment includes the image generation unit 11 including the light modulation element 16 having the red image generation region 16R that generates the red image light R2, the green image generation region 16G that generates the green image light G2, and the blue image generation region 16B that generates the blue image light B2, the integrator optical system 13 that superimposes the red image light R2, the green image light G2, and the blue image light B2 emitted from the image generation unit 11 and forms an image to generate the intermediate image Z, and the projection optical device 14 that enlarges and projects the intermediate image Z onto the screen SCR. The back focus position of the projection optical device 14 coincides with the position of the intermediate image Z. The red image generation region 16R, the green image generation region 16G, and the blue image generation region 16B are disposed in the same plane along the Y-axis direction, which is orthogonal to the emission direction of each of the image light beams R2, G2, and B2.

In the projector 10 according to the present embodiment, the three light emitters 17R, 17G, and 17B emit three color lights R1, G1, and B1, the light modulation element 16 generates three color image lights R2, G2, and B2 in three different image generation regions 16R, 16G, and 16B, the integrator optical system 13 superimposes and forms an image from the three color image lights R2, G2, and B2, and the projection optical device 14 enlarges and projects the generated intermediate image Z to display a full-color image. According to this configuration, since only one light modulation element 16 is required and a color separation optical system or a color synthesis optical system is not required, it is possible to obtain effects such as a reduction in the size of the projector 10, a reduction in the number of components, simplification of an assembly process, and a reduction in cost. Since a field sequential color system is not used, the problem of color breakup fundamentally does not occur. Since the light modulation element 16 does not need to include a color filter, and the color filter does not absorb light, it is possible to realize the projector 10 excellent in light utilization efficiency.

### Modifications

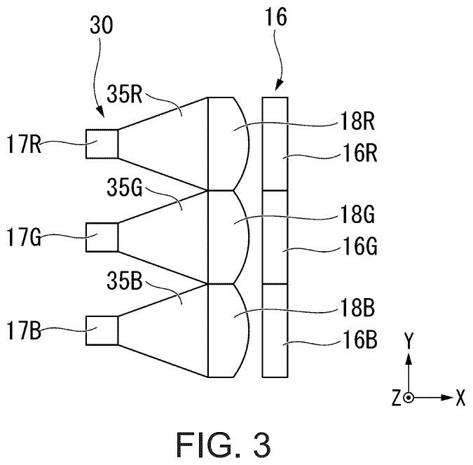

FIG. 3 is a diagram illustrating another configuration example of the light source device 30.

As illustrated in FIG. 3, the light source device 30 according to the present modifications includes a red light emitter 17R, a green light emitter 17G, a blue light emitter 17B, tapered rods 35R, 35G and 35B, and collimator lenses 18R, 18G, and 18B. The tapered rods 35R, 35G, and 35B are provided to correspond to the red light emitter 17R, the green light emitter 17G, and the blue light emitter 17B, respectively. The tapered rods 35R, 35G, and 35B are formed of a light transmissive member such as glass in a quadrangular pyramid shape that widens from the light incident side toward the light emission side. Alternatively, instead of a tapered rod, an internal reflection mirror may be used in which an inner surface of a cylindrical body having a truncated quadrangular pyramid shape is a reflection surface.

The collimator lenses 18R, 18G, and 18B are provided on the light emission side of the tapered rods 35R, 35G, and 35B. By this, the color light beams emitted from the light emitters 17R, 17G, and 17B are formed into a rectangular shape and have uniform illuminance. A reflective polarizer may be provided at the light emission side of the tapered rods 35R, 35G, and 35B. According to this configuration, since the polarization directions of the respective color light beams can be aligned while the respective color light beams are recursively reflected, the utilization efficiency of the respective color light beams can be enhanced.

### Second Embodiment

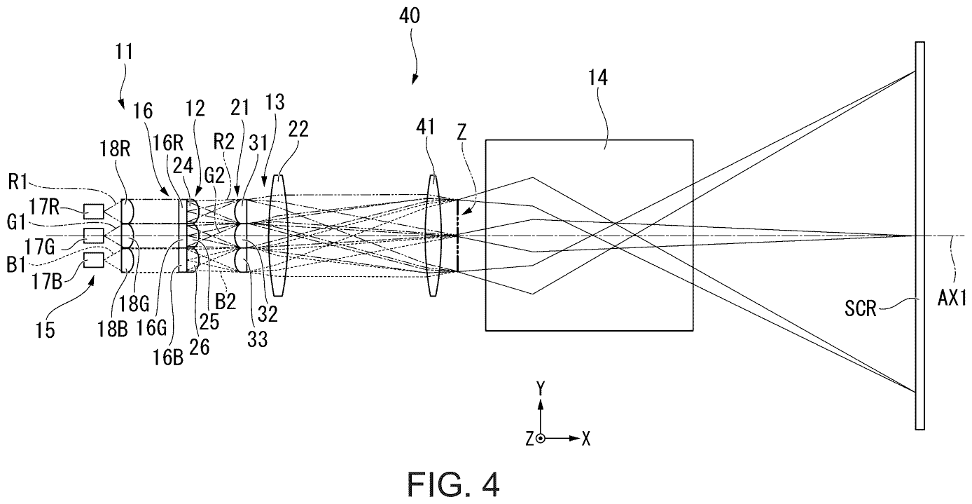

Hereinafter, a second embodiment of the present disclosure will be described with reference to FIG. 4.

Since the basic configuration of a projector according to the second embodiment is substantially the same as that in the first embodiment, the description of the basic configuration of the projector will be omitted.

FIG. 4 is a schematic configuration diagram of a projector 40 according to a second embodiment.

In FIG. 4, the same reference symbols are given to the same components as those in the drawings used in the first embodiment, and the description thereof will be omitted.

As illustrated in FIG. 4, the projector 40 according to the present embodiment includes the image generation unit 11, the second lens array 12, the integrator optical system 13 including the first lens array 21, a field lens 41, and the projection optical device 14.

The field lens 41 is disposed between the superimposing lens 22 and the intermediate image Z. The field lens 41 refracts at least a portion of the red image light R2, the green image light G2, and the blue image light B2 emitted from the superimposing lens 22 in a direction in which the principal rays of the image light approach a direction parallel to the optical axis of the superimposing lens 22, that is, to the system optical axis AX1. Therefore, the light rays incident on the upper end and the lower end of the intermediate image Z, as compared with the light rays shown in FIG. 4 of the first embodiment, are directed in a direction parallel to the system optical axis AX1.

The other configurations of the projector 40 are substantially the same as those of the projector according to the first embodiment.

### Effects of Second Embodiment

Also in the present embodiment, the same effects as those in the first embodiment are obtained, such as the effects that the projector 40 can be reduced in size, the number of components, the cost, and the like because only one light modulation element 16 is required, the effects that the projector 40 excellent in light utilization efficiency can be obtained because no color breakup occurs, and no light absorption by the color filter occurs.

In the present embodiment, the field lens 41 is provided at the light emission side of the superimposing lens 22, whereby the telecentricity is improved, and the image light R2, G2, and B2 emitted from the light modulation element 16 enter the projection lens of the projection optical device 14 in a direction closer to the perpendicular direction. This configuration can reduce vignetting of the image light R2, G2, and B2 on the projection lens, and improve the evenness of the color and the illuminance of the image projected onto the screen SCR.

### Third Embodiment

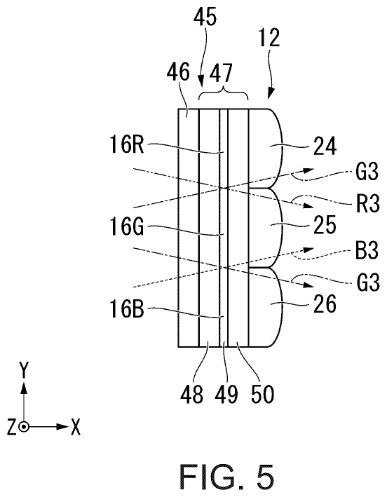

A third embodiment of the present disclosure will be described below with reference to FIGS. 5 to 8.

Since the basic configuration of a projector according to the third embodiment is substantially the same as that in the first embodiment, the description of the basic configuration of the projector will be omitted.

FIG. 5 illustrates a light modulation element 45 and a second lens array 12 in a projector according to a third embodiment.

In FIG. 5, the same reference symbols are given to the same components as those in the drawings used in the first embodiment, and the description thereof will be omitted.

As illustrated in FIG. 5, the projector according to the present embodiment includes the light modulation element 45, which forms an image generation unit, and the second lens array 12. The other components are the same as those of the first embodiment, and thus the illustration and description thereof will be omitted.

The light modulation element 45 includes an incident side dustproof glass 46 and a liquid crystal panel 47 in this order from the light incident side. The liquid crystal panel 47 includes an element substrate 48, a liquid crystal layer 49, and a counter substrate 50. The second lens array 12 is provided in contact with a light emission surface of a counter substrate 50 constituting the liquid crystal panel 47.

### Effects of Third Embodiment

Also in the present embodiment, it is possible to obtain substantially the same advantages as those in the first embodiment, such as the advantage that the projector can be reduced in size, the advantage that the number of components can be reduced, the advantage that the cost can be reduced, and the like because only one light modulation element 45 is required, the advantage that the projector excellent in light utilization efficiency can be obtained because no color breakup occurs, and the advantage that no light is absorbed by the color filter can be obtained.

Hereinafter, effects peculiar to the projector according to the present embodiment will be described.

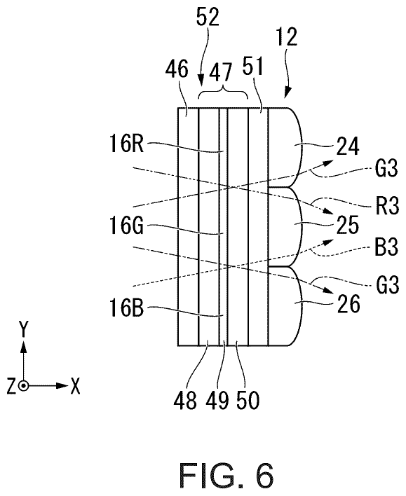

FIG. 6 is a diagram illustrating a general light modulation element 52 and a second lens array 12 as a comparative example. In FIG. 6, the same reference symbols are given to the same components as those in FIG. 5.

As illustrated in FIG. 6, a general light modulation element 52 has an emission side dustproof glass 51 on the light emission side of a counter substrate 50. Therefore, when the second lens array 12 is combined with the general light modulation element 52, the second lens array 12 is disposed on the light emission side of the emission side dustproof glass 51.

Here, a problem of the projector according to the first embodiment will be described.

As described in the first embodiment, the image light of each color emitted from each image generation region of the light modulation element is basically incident on a predetermined lens of the second lens array and a predetermined lens of the first lens array facing the image generation region. To be specific, as illustrated in FIG. 1, the red image light R2 is sequentially incident on the fourth lens 24 and the first lens 31. The green image light G2 is sequentially incident on the fifth lens 25 and the second lens 32. The blue image light B2 is sequentially incident on the sixth lens 26 and the third lens 33.

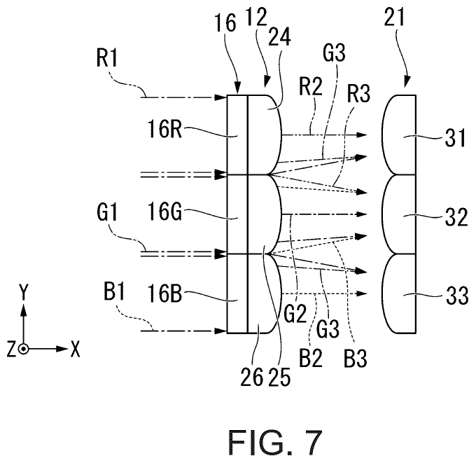

However, as illustrated in FIG. 7, the color lights R1, G1, and B1 incident as parallel light on the light modulation element 16 is diffracted inside the light modulation element 16 and emitted as divergent image light through the lenses 24, 25, and 26 of the second lens array 12. Thus, portions R3, G3, and B3 of color image light emitted from the respective image generation regions 16R, 16G, and 16B of the light modulation element 16 pass through the second lens array 12 and then enter the lenses adjacent to those facing the image generation regions of the first lens array 21. To be specific, the portion G3 of the green image light enters the first lens 31 onto which the red image light R2 is incident, the portion R3 of the red image light and the portion B3 of the blue image light B2 enter the second lens 32 onto which the green image light G2 is incident, and the portion G3 of the green image light enters the third lens 33 onto which the blue image light is incident. Hereinafter, the portions R3, G3, and B3 of the image light incident from the region other than the image generation region corresponding to the predetermined lens are referred to as stray light.

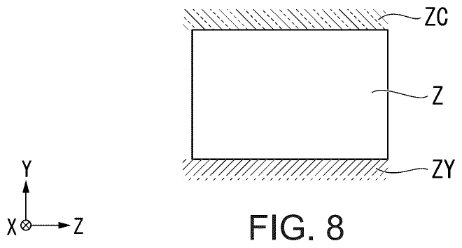

In this way, when the stray light R3, G3, and B3 is incident on a predetermined lens 31, 32, and 33 of the first lens array 21, for example, images by the stray light R3, G3, and B3 are generated above and below the intermediate image Z on the intermediate image plane. Therefore, for the intermediate image of the red image generation region 16R, an image by the green stray light G3 is generated on the upper side of the red intermediate image. For the intermediate image of the green image generation region 16G, an image by the blue stray light B3 is generated on the upper side of the green intermediate image, and an image by the red stray light R3 is generated on the lower side of the green intermediate image. For the intermediate image of the blue image generation region 16B, an image by the green stray light G3 is generated below the blue intermediate image. When such images are superimposed by the superimposing lens 22, as illustrated in FIG. 8, a cyan color image ZC is displayed on the upper side of the intermediate image Z, and a yellow image ZY is displayed on the lower side of the intermediate image Z. Since the images ZC and ZY of this type are enlarged and displayed onto the screen SCR by the projection optical device 14, there is a possibility that the display quality is deteriorated.

To solve this problem, in the projector according to the present embodiment, as described above, the second lens array 12 is provided in contact with the light emission surface of the counter substrate 50, and the projector has a configuration in which the emission side dustproof glass 51 is removed from the configuration of the comparative example illustrated in FIG. 6. Therefore, compared to the second lens array 12 in the first embodiment, the second lens array 12 in the present embodiment is located at a position closer to the liquid crystal layer 49, namely, closer to the image forming surface, by the thickness of the emission side dustproof glass 51. Therefore, in the case of the present embodiment, the ratio of the stray light R3, G3, and B3 emitted from the light modulation element 45 incident to the second lens array 12 is smaller than that in the first embodiment. As a result, the ratio of the stray light R3, G3, and B3 incident to the first lens array 21 is also reduced. This can reduce the phenomenon in which an image of an unintended color is displayed above and below the projected image.

Hereinafter, another countermeasure example will be described against the phenomenon in which an image of an unintended color is displayed above and below the projected image due to the stray light described above.

### First Countermeasure Example

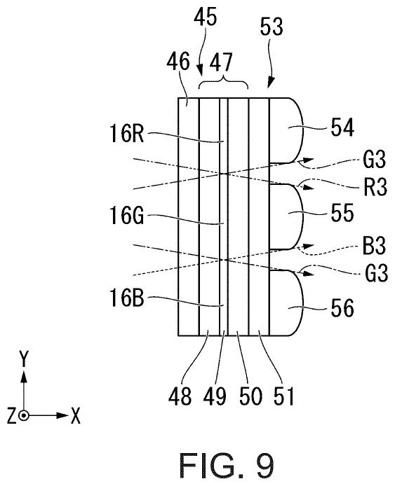

FIG. 9 is a diagram illustrating the light modulation element 45 and the second lens array 53 of the first countermeasure example.

In FIG. 9, the same reference symbols are given to the same components as those in FIG. 5 used in the third embodiment, and the description thereof will be omitted.

As illustrated in FIG. 9, the fourth lens 54, the fifth lens 55, and the sixth lens 56 constituting the second lens array 53 are not in contact with each other as in the example of FIG. 5, and are disposed to be separated from each other. Thus, the stray light G3, R3, and B3 emitted from the light modulation element 45 passes through the gaps between the lenses 54, 55, and 56 and is not incident on the lenses 54, 55, and 56. In other words, the fourth lens 54, the fifth lens 55, and the sixth lens 56 are disposed so as to avoid the regions through which the stray light G3, R3, and B3 pass. It should be noted that a light shielding film for shielding the stray light G3, R3, and B3 may be provided in a gap portion between the lenses 54, 55, and 56. In this example, an emission side dustproof glass 51 is provided on the light emission side of the counter substrate 50.

According to this configuration, as in the third embodiment, the ratio of the stray light G3, R3, and B3 emitted from the light modulation element 45 and incident on the second lens array 53 is reduced, and as a result, the ratio of the stray light G3, R3, and B3 incident on the first lens array 21 is also reduced. This can reduce the phenomenon in which an image of an unintended color is displayed above and below the projected image.

### Second Countermeasure Example

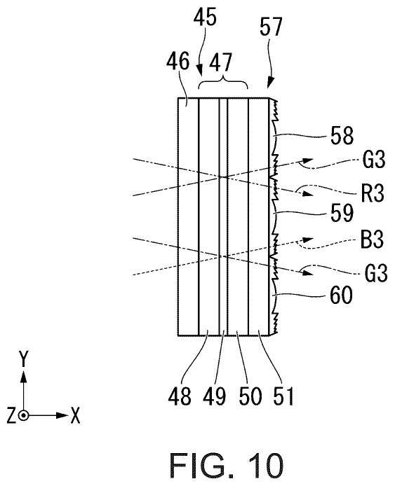

FIG. 10 is a diagram illustrating the light modulation element 45 and the second lens array 57 of the second countermeasure example. In FIG. 10, the same reference symbols are given to the same components as those in FIG. 5 used in the third embodiment, and the description thereof will be omitted.

As illustrated in FIG. 10, the fourth lens 58, the fifth lens 59, and the sixth lens 60 constituting the second lens array 57 are not general convex lenses as in the example of FIG. 5, but are Fresnel lenses. In this example, the emission side dustproof glass 51 is provided, but ideally, it is desirable that a Fresnel lens is directly provided on the light emission side of the counter substrate 50. When the lens surface of the Fresnel lens and the liquid crystal layer 49 are too close to each other, the pattern of the Fresnel lens is projected onto the screen SCR, and therefore, it is desirable that the lens surface of the Fresnel lens faces the light emission side.

According to this configuration, the position of the lens surface of the second lens array 57 is close to the liquid crystal layer 49, that is, the image forming surface, due to the effect of providing the Fresnel lens instead of a general convex lens. Therefore, the ratio of the stray light G3, R3, and B3 emitted from the light modulation element 45 entering the second lens array 57 decreases, and as a result, the ratio of the stray light G3, R3, and B3 entering the first lens array 21 also decreases. This can reduce the phenomenon in which an image of an unintended color is displayed above and below the projected image.

### Third Countermeasure Example

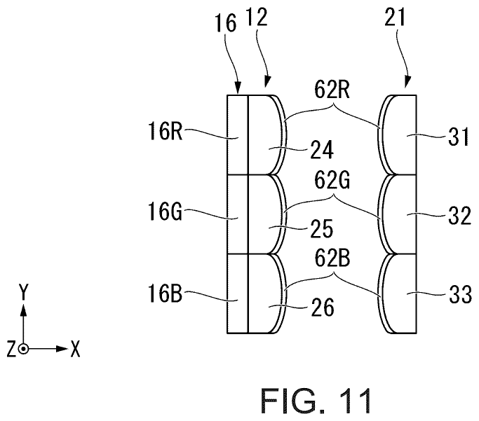

FIG. 11 is a diagram illustrating the light modulation element 16, the second lens array 12, and the first lens array 21 of the third countermeasure example.

In FIG. 11, the same reference symbols are given to the same components as those in FIG. 1 used in the first embodiment, and the description thereof will be omitted.

As illustrated in FIG. 11, a dichroic mirror 62R that transmits red light and reflects green light and blue light is provided in each of the fourth lens 24 and the first lens 31 facing the red image generation region 16R. A dichroic mirror 62G that transmits green light and reflects red light and blue light is provided on each of the fifth lens 25 and the second lens 32 facing the green image generation region 16G. A dichroic mirror 62B that transmits blue light and reflects red light and green light is provided on each of the sixth lens 26 and the third lens 33 facing the blue image generation region 16B. That is, the lenses facing the image generation regions 16R, 16G, and 16B are provided with dichroic mirrors 62R, 62G, and 62B that transmit the image light of the color emitted from the image generation region and reflect the image light of the other colors. It is desirable that the dichroic mirrors 62R, 62G, and 62B are provided at least at the first lens array 21 side, and the dichroic mirrors are not necessarily provided at the second lens array 12 side.

According to this configuration, since the dichroic mirrors 62R, 62G, and 62B are provided on the lenses of the second lens array 12 and the first lens array 21, even when the stray light emitted from the light modulation element 16 travels toward the adjacent lens, the stray light is reflected at least by the lens surfaces of the first lens array 21, and is suppressed from entering the first lens array 21. This can reduce the phenomenon in which an image of an unintended color is displayed above and below the projected image.

### Fourth Countermeasure Example

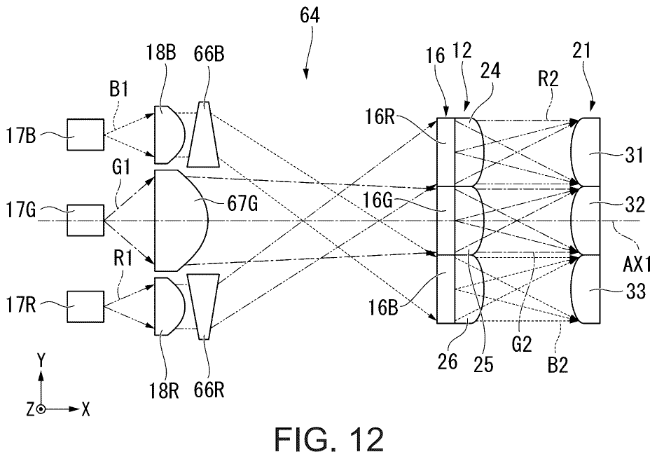

FIG. 12 is a diagram illustrating an image generation unit 64, a second lens array 12, and a first lens array 21 of a fourth countermeasure example.

As illustrated in FIG. 12, in the present example, the arrangement of the three light emitters constituting the light source device is opposite to that in the first embodiment. That is, the three light emitters are arranged along the Y-axis direction from the +Y side to the-Y side, in the order of the blue light emitter 17B, the green light emitter 17G, and the red light emitter 17R. The collimator lens 18B and the deflection prism 66B are disposed in this order at the light emission side of the blue light emitter 17B. The collimator lens 18R and the deflection prism 66R are disposed in this order on the light emission side of the red light emitter 17R. On the other hand, a condenser lens 67G is disposed at the light emission side of the green light emitter 17G.

The blue light B1 emitted from the blue light emitter 17B is collimated by the collimator lens 18B, and then the traveling direction is bent by the deflection prism 66B, and the blue light B1 travels obliquely in a direction intersecting the system optical axis AX1. By this, the blue light B1 is incident on the blue image generation region 16B of the light modulation element 16 obliquely in a direction away from the system optical axis AX1. Similarly, the red light R1 emitted from the red light emitter 17R is collimated by the collimator lens 18R, and then, the traveling direction is bent by the deflection prism 66R, and the red light travels obliquely in a direction intersecting the system optical axis AX1. The red light R1 is thereby incident on the red image generation region 16R of the light modulation element 16 obliquely in a direction away from the system optical axis AX1. On the other hand, the green light G1 emitted from the green light emitter 17G is incident perpendicularly on the green image generation region 16G of the light modulation element 16 in a state of being slightly converged by the condenser lens 67G. That is, the red light emitter 17R, the green light emitter 17G, and the blue light emitter 17B are configured to illuminate the light modulation element 16 at angles at which the principal rays of the red light R1, the green light G1, and the blue light B1 are separated from the system optical axis. AX1

According to this configuration, since the color light beams R1, G1, and B1 are incident on the image generation regions 16R, 16G, and 16B of the light modulation element 16 in directions away from each other, the amount of stray light emitted from the light modulation element 16 can be reduced. This can reduce the phenomenon in which an image of an unintended color is displayed above and below the projected image.

### Fourth Embodiment

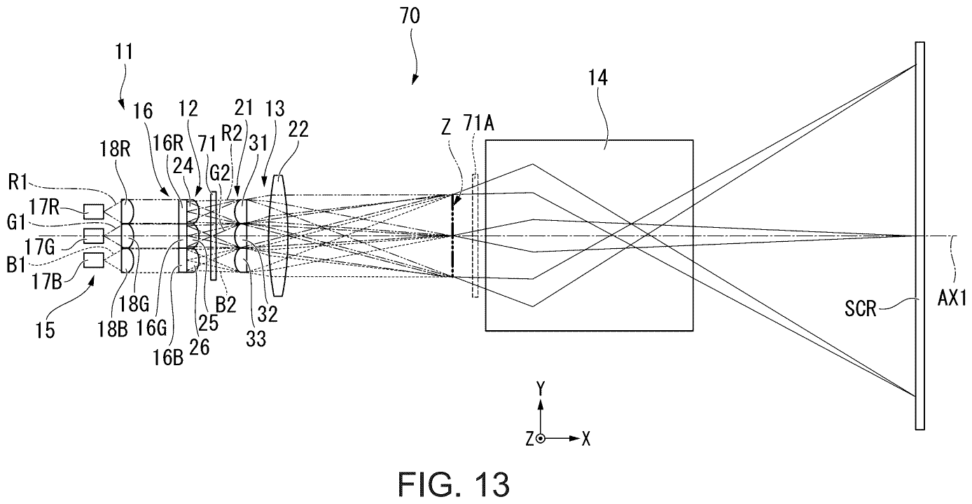

Hereinafter, a fourth embodiment of the present disclosure will be described with reference to FIG. 13.

Since the basic configuration of a projector according to the fourth embodiment is substantially the same as that in the first embodiment, the description of the basic configuration of the projector will be omitted.

FIG. 13 is a schematic configuration diagram of a projector 70 according to a fourth embodiment.

In FIG. 13, the same reference symbols are given to the same components as those in the diagrams used in the first embodiment, and the description thereof will be omitted.

As illustrated in FIG. 13, a projector 70 according to the present embodiment includes the image generation unit 11, the second lens array 12, the integrator optical system 13 including the first lens array 21, the projection optical device 14, and a pixel shift element 71.

The pixel shift element 71 is disposed between the image generation unit 11 and the integrator optical system 13, specifically, between the second lens array 12 and the first lens array 21. The pixel shift element 71 includes a glass plate that transmits the image lights R2, G2, and B2 emitted from the light modulation element 16 and actuators that oscillates the glass plate at high speed. It should be noted that the pixel shift element 71 may be disposed between the intermediate image Z and the projection optical device 14 (at the position indicated by the reference symbol 71A). The glass plate may have a function of an emission side polarizing plate. That is, the emission side polarizing plate may be used as a glass plate of the pixel shift element. The pixel shift element 71 may be provided at both of the two positions described above. In this case, if the pixel shift elements 71 and 71A are shifted in one axial direction and the shift directions are made orthogonal to each other, a pixel shift element capable of shifting pixels in two axial directions can be realized.

The other configurations of the projector 70 are substantially the same as those of the projector according to the first embodiment.

### Effects of Fourth Embodiment

Also in the present embodiment, it is possible to obtain substantially the same advantages as those in the first embodiment, such as the advantage that the projector 70 can be reduced in size, the number of components can be reduced, the cost can be reduced, and the like because only one light modulation element 16 is required, the advantage that the projector 70 can be obtained that is free from the occurrence of color breakup and that is excellent in light utilization efficiency because the color filter does not absorb light.

In the projector according to the first embodiment, since one liquid crystal panel is divided into three to form the image generation regions, the number of pixels per image generation region is one third of the number of pixels of the liquid crystal panel. Therefore, the resolution of the projected image is lower than the resolution that the liquid crystal panel originally has. In contrast, according to the present embodiment, since the projector 70 includes the pixel shift element 71, the number of pixels of the projected image can be increased in a pseudo manner by performing the pixel shift in two directions, for example, the horizontal direction and the vertical direction, and the resolution that the liquid crystal panel originally has can be maintained. The projector 70 according to the present embodiment can therefore provide a high-resolution projected image.

### Fifth Embodiment

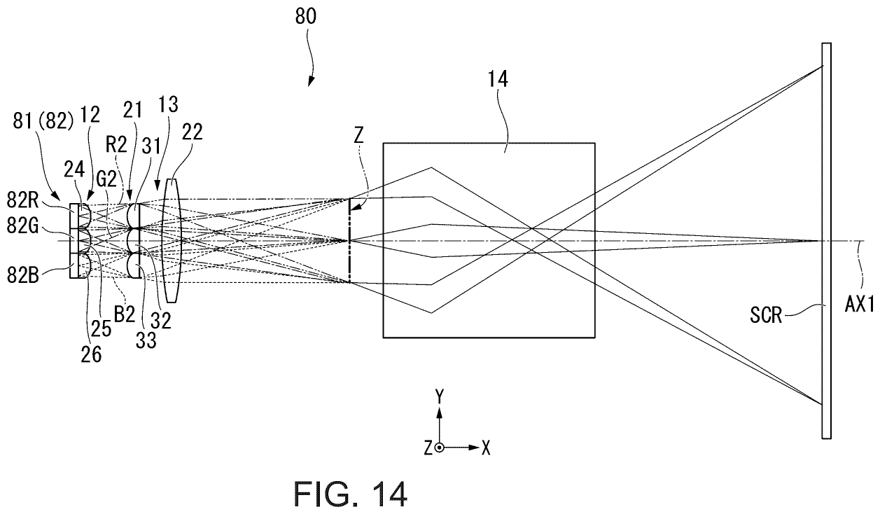

Hereinafter, a fifth embodiment of the present disclosure will be described with reference to FIG. 14.

Since the basic configuration of a projector according to the fifth embodiment is substantially the same as that in the first embodiment, the description of the basic configuration of the projector will be omitted.

FIG. 14 is a schematic configuration diagram of a projector 80 according to a fifth embodiment.

In FIG. 14, the same reference symbols are given to the same components as those in the drawings used in the first embodiment, and the description thereof will be omitted.

As illustrated in FIG. 14, the projector 80 according to the present embodiment includes an image generation unit 81, the second lens array 12, the integrator optical system 13 including the first lens array 21, and the projection optical device 14.

The image generation unit of the first embodiment includes the light source device and the light modulation element, whereas an image generation unit 81 of the present embodiment does not include the light source device but includes a self-luminous display element 82. As the self-luminous display element 82, a micro LED display in which a plurality of LEDs are arranged in an array shape, an organic electroluminescence (EL) display, a laser display, or the like is used. The self-luminous display element 82 has a red image generation region 82R, a green image generation region 82G, and a blue image generation region 82B, as does the liquid crystal panel of the first embodiment illustrated in FIG. 2.

The other configurations of the projector 80 are substantially the same as those of the projector according to the first embodiment.

### Effects of Fifth Embodiment

Also in the present embodiment, the same effects as those in the first embodiment are obtained, such as the effects that the projector 80 can be reduced in size, the number of components, cost, and the like because only one self-luminous display element 82 is required, the effects that the projector 80 excellent in light utilization efficiency can be obtained because no color breakup occurs, and no light absorption by a color filter occurs.

According to the present embodiment, since the light source device is not necessary, it is possible to achieve further reduction in size of the projector 80 and reduction in the number of components.

It should be noted that the technical scope of the present disclosure is not limited to the above-described embodiments, and various modifications can be made without departing from the spirit of the present disclosure. One aspect of the present disclosure may be configured by appropriately combining the features of the above-described embodiments.

The projector according to the embodiment described above includes the second lens array. However, when the parallelism of the image light emitted from the light modulation element or the self-luminous display elements is sufficiently high, the projector does not have to include the second lens array. If the parallelism of the image light is sufficiently high, even in a configuration in which the second lens array is not provided, the image light can be reliably incident on the lenses corresponding to the image light of the first lens array.

In addition, the specific description of the shape, the number, the arrangement, the material, and the like of each component of the projector is not limited to the embodiment described above, and can be changed as appropriate. In the embodiments described above, the light modulation element is formed of one liquid crystal panel, however, instead of this configuration, three liquid crystal panels may be disposed in one direction in the same plane. The self-luminous display elements may also be configured such that three self-luminous display elements are arranged in one direction in the same plane.

### Summary of the Present Disclosure

Hereinafter, an outline of the present disclosure is appended.

### Appendix 1

A projector includes an image generation unit including a first image generation region that generates first image light of a first wavelength band and a second image generation region that generates second image light of a second wavelength band different from the first wavelength band;
an integrator optical system that superimposes the first image light and the second image light emitted from the image generation unit and forms an image to generate an intermediate image; and
a projection optical device that enlarges and projects the intermediate image onto a projection surface, wherein
a back focus position of the projection optical device coincides with a position of the intermediate image and
the first image generation region and the second image generation region are disposed in the same plane along a second direction, which is orthogonal to a first direction that is an emission direction of the first image light and the second image light.

According to the configuration of Appendix 1, effects can be obtained such as downsizing of the projector, reduction in the number of components and cost, prevention of color breakup, and a projector with light utilization efficiency due to the absence of light absorption by color filters.

### Appendix 2

The projector according to the Appendix 1, wherein
the image generation unit further includes a third image generation region that generates third image light in a third wavelength band different from the first wavelength band and the second wavelength band,
the integrator optical system superimposes the first image light, the second image light, and the third image light emitted from the image generation unit on one another, and forms an image to generate the intermediate image, and
the first image generation region, the second image generation region, and the third image generation region are arranged in the same plane along the second direction.

According to the configuration of Appendix 2, it is possible to realize a projector capable of projecting a full-color image.

### Appendix 3

The projector according to the Appendix 2, wherein
the integrator optical system includes a first lens array disposed at the light emission side of the image generation unit and a superimposing lens disposed at the light emission side of the first lens array,
the first lens array includes a first lens that forms an image of the first image light, a second lens that forms an image of the second image light, and a third lens that forms an image of the third image light,
the first lens, the second lens, and the third lens are arranged along the second direction, and
the superimposing lens superimposes the first image light, the second image light, and the third image light emitted from the first lens array.

According to the configuration of the Appendix 3, it is possible to form the image lights into images and superimpose the images on each other using the first lens array and the superimposing lens, and to generate the intermediate image at the predetermined position in the front stage of the projection optical device.

### Appendix 4

The projector according to the Appendix 3, wherein
a dichroic mirror that transmits the light in the first wavelength band and that reflects light in a wavelength band other than the first wavelength band is provided on a light incident surface of the first lens,
a dichroic mirror that transmits the light in the second wavelength band and that reflects light other than the light in the second wavelength band is provided on a light incident surface of the second lens, and
a dichroic mirror that transmits light in the third wavelength band and that reflects light in a wavelength band other than the third wavelength band is provided on a light surface of the third lens.

According to the configuration of the Appendix 4, the stray light emitted from the image generation unit is reflected by the dichroic mirror provided in each lens of the first lens array, and is suppressed from entering the first lens array. This can reduce the phenomenon in which an image of an unintended color is displayed around the projected image.

### Appendix 5

The projector according to Appendix 3 or Appendix 4, further including
a second lens array disposed between the image generation unit and the first lens array, wherein
the second lens array includes a fourth lens that guides the first image light emitted from the first image generation region to the first lens, a fifth lens that guides the second image light emitted from the second image generation region to the second lens, and a sixth lens that guides the third image light emitted from the third image generation region to the third lens and
the fourth lens, the fifth lens, and the sixth lens are arranged along the second direction.

According to the configuration of Appendix 5, each image light emitted from the image generation unit is picked up by each lens of the second lens array, and is reliably transmitted to the first lens array in the subsequent stage. This makes it possible to increase the utilization efficiency of the respective color light beams.

### Appendix 6

The projector according to the Appendix 5, wherein
each of the fourth lens, the fifth lens, and the sixth lens is configured by a Fresnel lens.

According to the configuration of the Appendix 6, the proportion of the stray light emitted from the image generation unit and incident on the second lens array is reduced by the amount of reduction in the thickness of each lens of the second lens array, and the proportion of the stray light incident on the first lens array is also reduced. This can reduce the phenomenon in which an image of an unintended color is displayed around the projected image.

### Appendix 7

The projector according to any one of the Appendix 3 to 7, further including
a field lens disposed between the superimposing lens and the intermediate image, wherein
the field lens refracts at least a part of the first image light, the second image light, and the third image light emitted from the superimposing lens in a direction in which a principal ray of the image light approaches parallel to an optical axis of the superimposing lens.

According to the configuration of the Appendix 7, each image light emitted from the image generation unit enters the projection optical device from a direction closer to the vertical direction. Consequently, vignetting of each image light in the projection optical device is suppressed, and uniformity of color and illuminance of a projected image can be improved.

### Appendix 8

The projector according to any one of the Appendix 2 to 7, wherein
the image generation unit includes a light source device and a light modulation element,
the light source device includes a first light emitter that emits first light in the first wavelength band, a second light emitter that emits second light in the second wavelength band, and a third light emitter that emits third light in the third wavelength band, and
the light modulation element includes the first image generation region that modulates the first light emitted from the first light emitter to generate the first image light, the second image generation region that modulates the second light emitted from the second light emitter to generate the second image light, and the third image generation region that modulates the third light emitted from the third light emitter to generate the third image light.

According to the configuration of the Appendix 8, the image generation unit can be configured using the light source device and the light modulation element.

### Appendix 9

The projector according to the Appendix 8, wherein
the first light emitter, the second light emitter, and the third light emitter are arranged so that the light modulation element is illuminated at an angle at which a principal ray of each of the first light, the second light, and the third light is separated from a principal optical axis passing through a center of the light modulation element.

According to the configuration of the Appendix 9, since it is possible to reduce the amount of the stray light emitted from the light modulation element, it is possible to reduce the phenomenon that the image of the unintended color is displayed around the projected image.

### Appendix 10

The projector according to any one of the Appendix 2 to 7, wherein
the image generation unit includes a self-luminous display element and
the self-luminous display element includes the first image generation region that generates the first image light, the second image generation region that generates the second image light, and the third image generation region that generates the third image light.

According to the configuration of the Appendix 10, since the light source device is not necessary, it is possible to achieve miniaturization of the projector and reduction in the number of components.

### Appendix 11

The projector according to any one of Appendix 8 to 10, further including a pixel shift element disposed at least at one of between the image generation unit and the integrator optical system and between the intermediate image and the projection optical device.

According to the configuration of Appendix 11, since it is possible to suppress a decrease in resolution that is originally possessed by the light modulation element or the self-luminous display element, it is possible to obtain a projected image with high resolution.

What is claimed is:

1. A projector comprising:
an image generation unit including a first image generation region that generates first image light of a first wavelength band and a second image generation region that generates second image light of a second wavelength band different from the first wavelength band;
an integrator optical system that superimposes the first image light and the second image light emitted from the image generation unit and forms an image to generate an intermediate image; and
a projection optical device that enlarges and projects the intermediate image onto a projection surface, wherein
a back focus position of the projection optical device coincides with a position of the intermediate image and the first image generation region and the second image generation region are disposed in the same plane along a second direction, which is orthogonal to a first direction that is an emission direction of the first image light and the second image light.

2. The projector according to claim 1, wherein
the image generation unit further includes a third image generation region that generates third image light in a third wavelength band different from the first wavelength band and the second wavelength band,
the integrator optical system superimposes the first image light, the second image light, and the third image light emitted from the image generation unit on one another, and forms an image to generate the intermediate image, and
the first image generation region, the second image generation region, and the third image generation region are arranged in the same plane along the second direction.

3. The projector according to claim 2, wherein
the integrator optical system includes a first lens array disposed at the light emission side of the image generation unit and a superimposing lens disposed at the light emission side of the first lens array,
the first lens array includes a first lens that forms an image of the first image light, a second lens that forms an image of the second image light, and a third lens that forms an image of the third image light,
the first lens, the second lens, and the third lens are arranged along the second direction, and
the superimposing lens superimposes the first image light, the second image light, and the third image light emitted from the first lens array.

4. The projector according to claim 3, wherein
a dichroic mirror that transmits the light in the first wavelength band and that reflects light in a wavelength band other than the first wavelength band is provided on a light incident surface of the first lens,
a dichroic mirror that transmits the light in the second wavelength band and that reflects light other than the light in the second wavelength band is provided on a light incident surface of the second lens, and
a dichroic mirror that transmits light in the third wavelength band and that reflects light in a wavelength band other than the third wavelength band is provided on a light surface of the third lens.

5. The projector according to claim 3, further comprising:
a second lens array disposed between the image generation unit and the first lens array, wherein
the second lens array includes a fourth lens that guides the first image light emitted from the first image generation region to the first lens, a fifth lens that guides the second image light emitted from the second image generation region to the second lens, and a sixth lens that guides the third image light emitted from the third image generation region to the third lens and
the fourth lens, the fifth lens, and the sixth lens are arranged along the second direction.

6. The projector according to claim 5, wherein
each of the fourth lens, the fifth lens, and the sixth lens is configured by a Fresnel lens.

7. The projector according to claim 3, further comprising:
a field lens disposed between the superimposing lens and the intermediate image, wherein
the field lens refracts at least a part of the first image light, the second image light, and the third image light emitted from the superimposing lens in a direction in which a principal ray of the image light approaches parallel to an optical axis of the superimposing lens.

8. The projector according to claim 2, wherein
the image generation unit includes a light source device and a light modulation element,
the light source device includes a first light emitter that emits first light in the first wavelength band, a second light emitter that emits second light in the second wavelength band, and a third light emitter that emits third light in the third wavelength band, and
the light modulation element includes the first image generation region that modulates the first light emitted from the first light emitter to generate the first image light, the second image generation region that modulates the second light emitted from the second light emitter to generate the second image light, and the third image generation region that modulates the third light emitted from the third light emitter to generate the third image light.

9. The projector according to claim 8, wherein
the first light emitter, the second light emitter, and the third light emitter are arranged so that the light modulation element is illuminated at an angle at which a principal ray of each of the first light, the second light, and the third light is separated from a principal optical axis passing through a center of the light modulation element.

10. The projector according to claim 2, wherein
the image generation unit includes a self-luminous display element and
the self-luminous display element includes the first image generation region that generates the first image light, the second image generation region that generates the second image light, and the third image generation region that generates the third image light.

11. The projector according to claim 8, further comprising:
a pixel shift element disposed at least at one of between the image generation unit and the integrator optical system and between the intermediate image and the projection optical device.
